(19) United States
(12) Patent Application Publication
(10) Pub. No.: US 2011/0320078 A1
(43) Pub. Date: Dec. 29, 2011

(54) SYSTEMS AND METHODS FOR RETROFITTING COMBUSTIBLE FUEL VEHICLES TO A PLUG-IN ELECTRIC HYBRID

(76) Inventor: James C. McGill, Union City, CA (US)

(21) Appl. No.: 12/996,217

(22) PCT Filed: Jun. 2, 2009
(86) PCT No.: PCT/US2009/045904

§ 371 Date: Aug. 12, 2011

Related U.S. Application Data
(60) Provisional application No. 61/058,481, filed on Jun. 3, 2008.

(51) Int. Cl. B60W 20/00

(52) U.S. Cl. 701/22; 180/65.265; 903/930

(57) ABSTRACT

A system (1) can retrofit a combustible fuel vehicle to form a plug-in electric hybrid vehicle An electric motor/generator unit (4) has an electric motor mode and an electric generator mode and can be switched between modes in response to a switching signal. A vehicle drive train interconnection (8) is connected with a drive shaft (5) of the motor generator (4) to connect the motor generator (4) to the vehicle drive train A sensor (32) determines an operating condition of the vehicle corresponding to movement of the vehicle. A rechargeable battery (2) is connected to the motor/generator (4) to provide electrical power to the motor for generator in the motor mode and to receive electrical power from the motor generator in the generator mode The battery (2) has a recharge plug (9) and a recharging circuit so that the battery (2) can be recharged by plugging it into a source of electrical power. A controller (3) is connected with the motor generator unit 4, the rechargeable battery (2) and the sensor (32).

### REFERENCE TO RELATED APPLICATION

This application claims benefit of U.S. Provisional Patent Application No. 61/058,481, filed Jun. 3, 2008, which is incorporated herein by reference.

### BACKGROUND OF THE INVENTION

1. Field of the Invention

The present invention relates to systems and methods for retrofitting combustible fuel vehicles so as to form plug-in electric hybrid vehicles. The goal is to reduce the total amount of combustible fuel that is used in an internal combustion engine in a typical vehicle or boat, better managing the energy used by the vehicle and assisting the vehicle through the use of the electricity produced by the vehicle and from external sources of electricity.

2. State of the Prior Art

Currently a great deal of attention is being paid to the development of technology that will reduce the amount of traditional fuels used for transportation in vehicles such as cars, trucks and boats. Increasing the efficiency of traditional combustible fuel such as gasoline and diesel fuel and enabling the use of other sources of power such as electricity will save fuel, reduce total energy costs and reduce the impact on the environment due to the use of traditional combustible fuels. One way to do this is to try to convert traditional fuel vehicles into hybrid vehicles that use not only the traditional fuel, but also, for example, a separate source of energy such as electricity from a battery.

A hybrid vehicle conversion kit is known from U.S. Patent Publication 2006/0000650. However, this system involves mounting a motor/generator unit between the transmission and the drive shaft of the vehicle.

Also known are a system and method for minimizing energy consumption in hybrid vehicles as set forth in U.S. Pat. No. 7,013,205; a fly wheel electric transmission apparatus as set forth in U.S. Pat. No. 4,309,620; and inputs for optimizing performance in hybrid vehicles as set forth in U.S. Patent Publication 2006/0278449.

### OBJECT AND SUMMARY OF THE PRESENT INVENTION

The goal of the present invention is to reduce cost to the user of a vehicle and to reduce greenhouse gas emissions to the environment. Accordingly, the present invention provides for easy retrofitting of an existing vehicle or boat with a system that will reduce the use of consumable, combustible fuel by increasing fuel economy and by using energy sources that are better for the environment. It has been known for a long period of time that electrically powered vehicles are much more efficient than typical, traditional vehicles that are powered by an internal combustion engine. Accordingly, the present invention provides for the use of electric power from a rechargeable battery source to assist the internal combustion engine in a typical vehicle or boat. Moreover, the present invention provides a relatively easy system and method for retrofitting an existing vehicle into a plug-in electric hybrid vehicle.

In one aspect of the invention, a system for retrofitting a combustible fuel vehicle to form a plug-in electric hybrid vehicle includes an electric motor/generator unit that has an electric motor mode and an electric generator mode and that can be switched between the motor mode and the generator mode in response to a switching signal. A vehicle drive train interconnection is connected with the drive shaft of the motor generator to connect the motor generator to the vehicle drive train so that the motor/generator unit can provide power into the vehicle drive train and receive power from the vehicle drive train.

A sensor determines an operating condition of the vehicle which corresponds to movement of the vehicle. A rechargeable battery is connected to the motor/generator so as to provide power to and receive power from the motor generator in its respective modes. The rechargeable battery has a recharge plug and a recharging circuit so that the battery can be recharged by plugging the recharge plug into a source of electrical power. A controller connected with the motor/generator unit, the rechargeable battery and the sensor determines, in response to a signal from the sensor, if the vehicle is moving and if it is accelerating, decelerating or moving at a constant speed. The controller controls the motor/generator unit and the rechargeable battery to provide power to the motor/generator in the motor mode and to receive power from the motor/generator in the generator mode to recharge the rechargeable battery. It switches the motor/generator unit between the motor mode and the generator mode based upon determining whether the vehicle is accelerating, decelerating or moving at a constant speed.

The vehicle drive train interconnection can include a clutch mechanism that is connected to and operated by the controller. For example, the engine power steering pulley could be mounted to the shaft to be interconnected with the drive train of the vehicle through a suitable belt. A clutch can be used to disconnect the connection to the drive train under the control of the controller, further.

Alternatively, the vehicle drive train interconnection can include the pulley or gear connection at the differential of the vehicle. The motor/generator unit can be mounted to the differential by means of a suitable bracket and connected to the vehicle drive train through a pulley or gear mechanism connecting, for example, through the differential flange that is used to connect to the drive shaft flange.

In an alternative embodiment, the system can comprise a power assist unit that provides a separate power assist to the vehicle. A suitable controller, battery and motor/generator unit, as described above, including a recharging circuit and recharging plug, can be mounted together with a drive wheel supported through an adjustable fluid shock, as a unit. Thus, the additional drive wheel is driven by the motor/generator unit under the control of the controller. The battery may be recharged in the same manner, through the motor/generator unit or by plugging it into a separate source of electricity. The unit can form a separate attachment to a vehicle for example by connecting it with a standard trailer hitch.

A modification of the power assist unit can allow it to be attached to the rear of a tractor of a tractor/trailer truck, either by a hitch mechanism or with a more permanent connection.

The system can also replace the motor/generator unit with an electric motor so that the concept can be applied to a boat. In this case, the motor is connected by a separate transmission mechanism to the propeller shaft under the control of the controller. The motor is driven by the electric energy of the rechargeable battery, which can be recharged by plugging it into a separate source of electricity.

### BRIEF DESCRIPTION OF THE DRAWINGS

FIG. 1 is a system diagram of a first embodiment of the present invention;

FIG. 2 is a system diagram of a second embodiment of the present invention;

FIG. 3 is a schematic view of a power assist unit according to a third embodiment of the present invention;

FIG. 4 is a schematic view of the power assist unit illustrated in FIG. 3;

FIG. 5 is a schematic illustration of a power assist unit adapted to a tractor/trailer truck;

FIG. 6 is a system diagram illustrating the replacement of a standard alternator or generator with a motor/generator unit in accordance with the present invention;

FIG. 7 is a system diagram showing the flow of information to a controller used to control a power assist unit or motor/generator or a combination thereof as described in the prior embodiments;

FIG. 8 is a schematic view of a boat in accordance with a further embodiment of the present invention;

FIG. 9 is a system diagram for the system of FIG. 8;

FIG. 10 is a system diagram of a variation of the above embodiments using an electric motor to assist a combustible fuel engine; and

FIG. 11 is a system diagram of another variation of the use of an electric motor to assist a combustible fuel engine.

### DETAILED DESCRIPTION OF THE PREFERRED EMBODIMENTS

Specific examples of systems for retrofitting combustible fuel vehicles to form plug-in electric hybrid vehicles are described below with respect to several embodiments. While the embodiments are described separately, a number of the aspects of the embodiments carry through between the embodiments, and a number of the embodiments are usable together. Similar reference numerals are used for similar components.

### First Embodiment

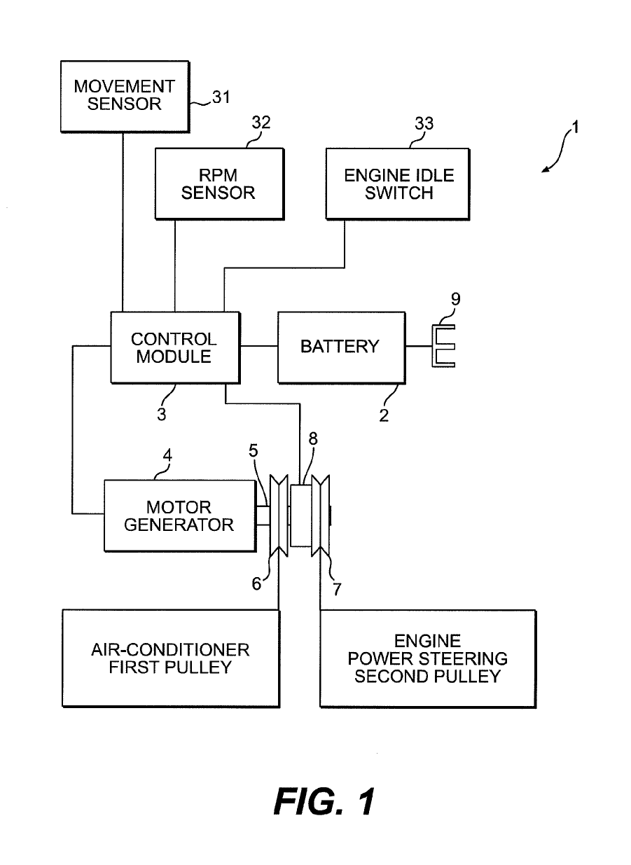

A system 1 is schematically illustrated in FIG. 1, which can be incorporated into a standard combustion fuel vehicle such as a typical gasoline powered car to be retrofitted with the system to form a plug-in electric hybrid vehicle. The system 1 includes a motor/generator (M/G) 4 that is a combined electric motor and generator that can be switched between a motor mode and a generator mode in response to a signal from a controller. The M/G 4 can, according to this embodiment, replace the standard alternator vehicle. There are a number of known standard electric motors that have the option of switching the motors to a generator mode through a switch mechanism, and such known standard electric motors with this option are suitable s the M/G for use with this and the other embodiments described below.

A drive shaft 5 of the M/G 4 has a vehicle drive train interconnection that interconnects the M/G 4 with the drive train of the vehicle so as to be able to supply power to the drive train to assist the engine of the vehicle and to receive power from the drive train to generate electricity. In this embodiment, an air-conditioner pulley 6 (as a first pulley) and a power steering pulley 7 (as a second pulley) are connected with the drive shaft 5. A clutch 8 is located between the A/C pulley 6 and the power steering pulley 7. While two pulleys are shown in this embodiment, only one pulley is necessary to interconnect the M/G 4 with the drive train. In this embodiment, the pulleys are directly attached to the drive shaft 5.

The clutch 8 forms a clutch mechanism that can be engaged or disengaged upon receipt of a signal from the controller, formed by the control module 3. Alternatively, or in addition to, the signal from the control module 3, the clutch 8 can also be operated by a manual switch (not shown). The clutch mechanism is preferably a standard electromagnetic clutch design that is controlled by a switch circuit upon receipt of a signal, which type of electromagnetic clutch is per se known.

With this arrangement, a first pulley system including the air-conditioner pulley 6 is connected so as to operate the air-conditioner or other appliances when the M/G 4 is in a motor mode upon receipt of a signal from the control module 3. A second pulley system that includes the power steering pulley 7 is connected to the engine and other appliances, such as the power steering pump, which needs to be operated while the combustible fuel engine is running. The second pulley system can be disengaged through the clutch 8 when the engine is not running.

The control module 3 is connected to a movement sensor 31. The movement sensor 31 is one that measures the distance that the vehicle moves relative to the ground or pavement. There are several off the shelf position or movement sensors that can be used to provide an output signal that indicates a displacement of a shaft or a wheel, for example. Thus the movement sensor 31 can be attached to the transmission, a wheel drive shaft, directly to a wheel, or to the existing electrical system so as to measure distance that is traveled by the vehicle relative to time. Accordingly, the movement sensor 31 is one that allows the control module to determine if the vehicle is moving relative to the ground; the rate of acceleration of the vehicle relative to the ground; the rate of deceleration of the vehicle relative to the ground; and if the vehicle is moving at a constant speed relative to the ground.

Preferably the system 1 further includes a rotation-per-minute (RPM) sensor 32 detecting the rpm of the combustible fuel engine and an engine idle switch 33, both connected to the control module 3 so that the control module 3 can use the information there from in controlling the mode of operation of the M/G 4. The engine idle switch 33 determines when there is no pressure on the accelerator paddle of the vehicle. After lapse of a predetermined period of time with no pressure on the accelerator paddle, the control module 3 disconnects the clutch 8 and turns off the combustible fuel engine. The control module 3 is further programmed to prevent the RPM of the engine from dropping below a predetermined amount.

The M/G 4 is driven by the energy from a rechargeable storage battery 2 that is connected to the M/G 4 and under the control of the control module 3. The battery 2 has a recharge plug 9, and the battery further includes a recharging circuit so that battery 2 can be connected to an outside electric power source and recharged. The recharging circuit as such can be a component included with the battery 2, or can be part of the control module 3. The arrangement of the battery with respect to the control module 3 and the plug 9 illustrated in FIG. 1 is simply for purposes of illustration, it is noted; the recharging of the battery is under the control of the control module 3 and the recharging circuit. The battery 2 is thus used to power the M/G 4 when the M/G 4 is in the motor mode to start the engine and to assist the engine while the engine is running and when the clutch 8 is engaged to the M/G 4. Further, the battery 2 is recharged by the M/G 4 when the M/G 4 is in the generator mode with the engine running and with the clutch 8 engaged. The mode of the M/G 4 is determined by the control module 3, or by a manually operated switch.

The controller, represented by the control module 3, is a computer that includes a microprocessor. Control modules are currently used to monitor and control automotive engine systems, and as such are per se known. The controller according to the present invention is one that is capable of receiving the information signals indicated herein, using this information to perform necessary calculations for purposes of the control indicated herein, and outputting the control signals indicated herein. The controller is thus implemented by programming the microprocessor to carry out the signal input, calculations, and signal output as set forth herein for this and the later described embodiments.

The battery 2 can be charged in one of four different ways, or through a combination of these four different ways.
1. With the M/G 4 set in the generating mode, either manually or under the control of the control module 3, with the engine running, and with the clutch 8 engaged to the engine via the second pulley system, the engine recharges the battery.
2. With the control module 3 controlling the clutch 8, with the clutch 8 engaged so as to allow the second pulley system to drive the M/G 4 and with the engine running, when the control module 3 detects vehicle deceleration at a predetermined amount or above, the control module 3 switches the M/G 4 to the generator mode to recharge the battery. The amount of deceleration is computed by the control module 3 from the information that is received from the movement sensor 31. The load that is placed on the M/G 4 in the generator mode is applied proportionally to the deceleration that is computed by the control module 3.
3. When the control module 3 detects that the battery is getting too low in charge (or in response to a direct manual instruction from the operator), the control module 3 sets the M/G 4 to the generator mode if the engine is running with the clutch 8 being engaged to the engine via the second pulley system.
4. The battery is recharged by plugging the battery in to an external electrical power source using the plug 9. The external power source may include the power grid, a remote generator, and solar panels which could for example be mounted to the vehicle itself.

### Retrofitting the Vehicle

In the present embodiment, the M/G 4 replaces the alternator. The air-conditioner pulley 6 and the power steering pulley 7 are mounted with the drive shaft 5 of the motor generator 4, and in this way the motor generator has a vehicle drive train interconnection. The movement sensor 31, RPM sensor 32 and engine idle switch 33 are incorporated into the vehicle at appropriate locations. The battery 2 may be in addition to, or may be in replacement of, the existing vehicle battery. However, the battery 2 must be a rechargeable battery 2 including a recharging circuit, which may be part of the control module 3 or mounted integrally with the battery 2, so that the battery can be recharged both through the M/G 4 and both through plugging the battery 2 into a source of electrical power using the plug 9.

### Operating the System

The sequence of the operation of the M/G 4 and the mode in which it will operate is determined by the control module 3, or by a manual switch.

Vehicle Not Moving Relative to Ground as Detected by Movement Sensor and Computed by Control Module

The control module 3 determines the sequence of the operation of the M/G 4 and the mode in which it will operate. This can also be by manual switch by the vehicle operator.

If the vehicle is not moving relative to the ground as detected by the movement sensor 31 and as computed by the control module 3, then the combustible fuel engine will be turned off after a predetermined period of time or by a switch that is activated by the operator of the vehicle. At the same time that the engine is turned off the clutch 8 is disengaged from the M/G 4. However, the first pulley system allows the M/G 4 to continue to power the A/C; it does so by either remaining in or being switched to the motor mode either manually or under the control of the control module 3, receiving its electrical energy from the battery. Other accessories that can be powered by the battery will also continue to receive energy from the battery in order to run such accessories.

If the A/C or any other accessories that are powered by the M/G 4 are not needed but are left on, then the M/G 4 will be shut off by the control module 3 in order to conserve the battery life. In this position, the internal combustion engine will not be consuming fuel, as it will be shut off. Accessories that can be powered by the battery 2 and not by the M/G 4 are connected by wire and under the control of the control module 3.

Vehicle Moving Relative to Ground

When the vehicle accelerator paddle is depressed, or a switch is activated manually, or a combination thereof, with the intent to move the vehicle forward, the clutch 8 will engage so as to form the vehicle drive train interconnection; then the M/G 4 will be powered by the battery 2 under the control of the control module 3 to start the internal combustion engine. A normal engine starter motor may be used to help to starting the engine, but a normal starter motor may not be necessary, depending on the power of the particular M/G 4 employed for the particular vehicle. In other words, it is not necessary to have a standard starter motor if the M/G 4 is sufficiently strong to start the engine alone. Thus, by choosing a M/G 4 of sufficient power a standard starter motor component may be eliminated.

A preferred option upon startup of the engine is to have the control module 3 place the A/C and/or other accessories that are powered through the first pulley system in the off position for a predetermined period of time if the A/C and other accessories are in the on condition. This allows the M/G 4 to stop before engaging the clutch 8. This will help to prevent the clutch from excessive wear, and also increases the amount the power that is available to start the engine and to assist the engine during initial acceleration upon start up from a stopped.

With vehicles that have a manual transmission, a clutch switch is connected to the control module 3 so that when the clutch is depressed for a predetermined period of time the engine will be turned off as described above. If the clutch is again released after the engine has been turned off, then the engine is then restarted.

As the vehicle moves, the M/G 4 stays in the motor mode in order to assist the engine so as to save fuel until the M/G 4 is either shut off manually or shut off under the control of the control module 3. The control module 3 detects vehicle acceleration through the input from, for example, movement sensor 31. This detection can also include input from another type of sensor, such as RPM sensor 32, and such as through a brake light sensor to ensure that the brake light is off and that vehicle acceleration is intended by the operator. Thus, the control module 3 detects the vehicle acceleration and increases power input to the M/G 4 from the battery 2 in the motor mode in order to assist the combustible fuel engine and to save combustible fuel. The control module 3 is preferably programmed to increase the amount of power that is input to the M/G 4 in the motor mode proportionate to the amount of acceleration of the vehicle.

If the control module 3 senses vehicle deceleration of a predetermined amount or more, then the M/G 4 will be switched by the control module 3 to the generator mode. Then the M/G 4 will be controlled by the control module 3 to apply a load on the M/G 4 that is proportionate to the amount of deceleration, thus producing electrical energy that recharges the battery 2, under the control of the recharging circuit and the control module 3. The RPM of the engine is monitored through the RPM sensor 32 by the control module 3; the control module 3 adjusts the load of the M/G 4 in the generator mode as necessary to ensure that the engine RPM does not drop below a predetermined amount.

In the above-described embodiment, the power steering pulley 7 has been illustrated as being on one side of the clutch 8. However, the power steering pulley could be located on the other side of the clutch 8, and a separate pulley could be provided for the vehicle drive train interconnection. This will allow the power steering pump to continue to be operated by the M/G 4 even when the combustion fuel engine has been turned off and the M/G 4 has been disconnected from the vehicle drive train by the clutch 8. This may be a preferable arrangement in situations where the vehicle is moving but the accelerator paddle is not being pressed by the operator. In other words, the vehicle may be coasting, and it may be desirable to save energy to shutoff the combustion fuel engine, yet still necessary to drive the power steering pump and the other accessories of the vehicle.

### Second Embodiment

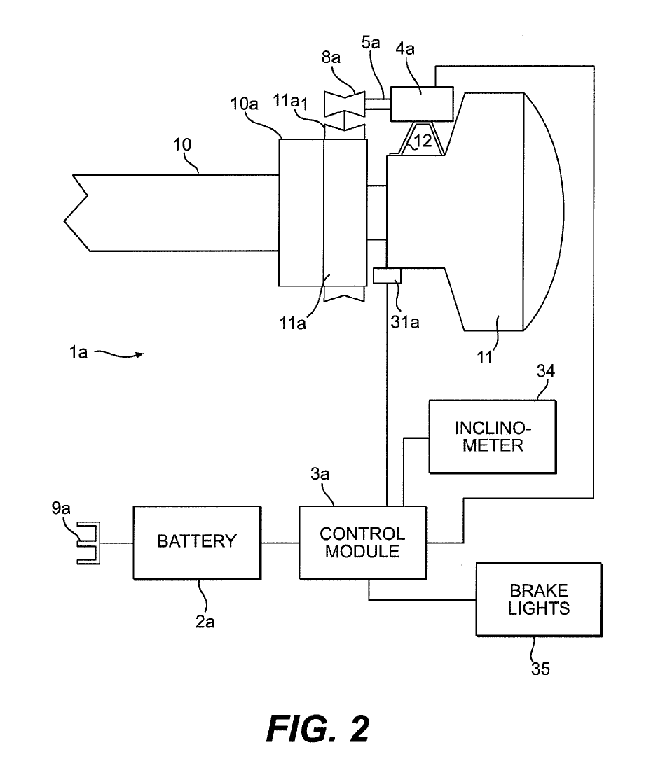

A second embodiment according to the present invention is described with respect to FIG. 2. In this figure similarly labeled components are similar to those of FIG. 1. This includes the M/G 4a, control module 3a, battery 2a, plug 9a and movement sensor 31a. As such, description of these components corresponds to the description above, and for the most part only differences in operation will be described below.

In this embodiment, the M/G 4a is attached to the differential 11 of a vehicle. The M/G 4a is thus connected to the drive of the differential 11 by a gear or pulley. A bracket 12 is a mounting bracket that mounts the M/G 4a to the differential 11. This supports the M/G 4a and allows a gear or pulley system 8a to be driven by drive shaft 5a of the M/G 4a.

The gear or pulley system 8a includes a gear or pulley 11a1 that is mounted to differential flange 11a of the differential 11. Thus, the M/G 4a is provided with a vehicle drive train interconnection by means of the gear or pulley 8a and the gear or pulley 11a1. The differential flange 11a is connected with a drive shaft flange 10a of vehicle drive shaft 10 that is connected to the combustible fuel engine of the vehicle. Thus the M/G 4a can provide additional power to the drive wheels through this drive train interconnection.

Control module 3a is connected with the movement sensor 31a as described above with respect to the embodiment of FIG. 1, and operates in the same way. The control module 3a controls the battery load that is supplied to the M/G 4a in the motor mode and the recharging load to recharge the battery in the generator mode, and this operation can be carried out in the same way as described above with respect to the embodiment of FIG. 1.

As with respect to the embodiment of FIG. 1, the battery 2a also includes a recharge plug 9a to recharge the battery 2a by being connected to an electrical power source through a recharging circuit that allows the electric power source to turn off when the battery has reached a full charge.

It is noted that the embodiment as described with respect to FIG. 2 can work without the use of the arrangement that is described in FIG. 1, or can work in combination together with the embodiment of FIG. 1.

### Battery Recharging

1. The battery may be recharged by the M/G 4a being set in the generating mode, either manually or under the control of the control module 3a, with the combustible fuel engine running. The existing vehicle charging system could also be used to charge the battery independently of the M/G 4 if the alternator of the vehicle is not replaced by the M/G 4.

2. The control module 3a switches the M/G 4a to the generator mode when a deceleration is detected above a predetermined amount.

3. The control module 3a recharges the battery using the M/G 4 of the embodiment of FIG. 1 described above, under the control of the control module 3a.

4. The battery is recharged by plugging it to an external power source such as the power grid, a remote generator, solar panels, etc. as described above.

### Sequence of Operation

The control module 3a obtains continuous information from the movement sensor and a brake light circuit 35. Based upon this information, the control module 3a determines the mode of operation of the M/G 4a and sets it either in the motor mode or in the generator mode.

The control module 3a will then switch the M/G 4a to be in the motor mode or allow the M/G 4a to remain in the motor mode upon detecting vehicle acceleration above a predetermined amount when the brake lights are off based on the input from the movement sensor 31a. The power that is input to the M/G 4a in the motor mode is increased in proportion to the amount of acceleration of the vehicle. This assists the engine in saving the combustible fuel.

If the control module 3a detects deceleration of the vehicle of a predetermined amount, and/or detects that the brake light circuit is on, the control module 3a will switch the M/G 4a to the generator mode in order to apply a load to the M/G 4a to charge the battery. The load will be proportional to the amount of the deceleration of the vehicle.

If the control module 3a senses constant movement, or steady speed, within a predetermined tolerance, then the control module 3a maintains the speed constant within a predetermined tolerance by applying a load to the M/G 4a in the motor mode. However, if the control module 3a detects the brake circuit being on, the M/G 4a will be switched by the control module 3a to the generator mode to apply a load to charge the battery proportional to the vehicle's deceleration.

A manual switch is also preferably provided so that the operator of the vehicle can switch the mode of the M/G 4a by activating the manual switch.

### Sequence of Operation of the Embodiments of FIGS. 1 and 2 in Combination

As noted above, a combustible fuel vehicle can be retrofitted with the embodiments of both FIG. 1 and FIG. 2. In this case, the controller might include both the control module 3 and the control module 3a for the respective circuits, or a single control module may be used to control both systems.

The sequence of the operation of the M/G 4 and the M/G 4a and the modes in which they operate are determined by the control module or by a manual switch.

If the control module determines, due to detection by the movement sensor 31 or 31a, that the vehicle is not moving relative to the ground, then the combustible fuel engine will be turned off after a predetermined period of time or by a switch that is activated by the operator of the vehicle.

At the same time that the engine is turned off the clutch 8 is disengaged from the M/G 4. However, the M/G 4 is allowed to continue to power the A/C through the first pulley system in the motor mode of the M/G 4 by being switched to the motor mode either manually or under the control of the control module, receiving electrical energy from the battery. Other accessories that can be powered directly by the battery may also continue to be run.

If the control module determines that the A/C or other accessories that are powered by the M/G 4 are not needed, but have been left on, then the M/G 4 will be shut off in order to conserve the battery life. In this position the internal combustion engine would not be consuming fuel as it would already have been shut off. It is noted that accessories that can be powered by the battery but not by the M/G 4 will be connected by wire. In this condition, the M/G 4a is powered off.

When the vehicle accelerator paddle is depressed, or when a switch is manually activated, or a combination thereof occurs, with the intent to move the vehicle forward, the clutch 8 will engage the second pulley system to start the engine, as described with respect to the embodiment of FIG. 1. As also described above, it is preferable that the A/C and other accessories that are powered through the first pulley system be placed in the off position by the control module 3 for a predetermined period of time in order to allow the M/G 4 to stop before engaging the clutch 8, thus preventing the clutch from excessive wear, and thus also increasing the amount of power that is available to start the engine and to assist the engine during initial acceleration.

The M/G 4 remains in the motor mode in order to assist the engine and to save fuel used by the combustible fuel engine until the M/G 4 is either shutoff manual or is shutoff by the control module. The M/G 4a is powered on at the same time as the M/G 4, receiving its operational control signals from the control module 3, 3a. As noted, while a separate control module may be provided, it is not necessary.

Thus, the control module detects the vehicle acceleration and increases the amount of power that is input to the M/G 4 and the M/G 4a in the motor mode in order to assist the combustible fuel engine in order to save fuel. Preferably the control module increases the amount of power that is input to the M/G 4 and the M/G 4a in the motor mode in an amount proportional to the amount of acceleration of the vehicle.

If the control module determines that the vehicle is decelerating a predetermined amount, then the control module switches the M/G 4 and the M/G 4a to the generator mode. At this mode, a load is applied on the M/G 4 and the M/G 4a that is proportional to the amount of deceleration, producing electrical energy to charge the battery. In any case, however, the control module will monitor the RPM of the engine through the RPM sensor 32 and will adjust the load of the M/G 4 and the M/G 4a so that the engine RPMs will not drop below a predetermined amount.

The control module is further programmed to turn off either the M/G 4 of FIG. 1 or the M/G 4a of FIG. 2 if only one of them is needed in the motor mode and if only one of them is needed for recharging in the generator mode.

### Embodiment 3

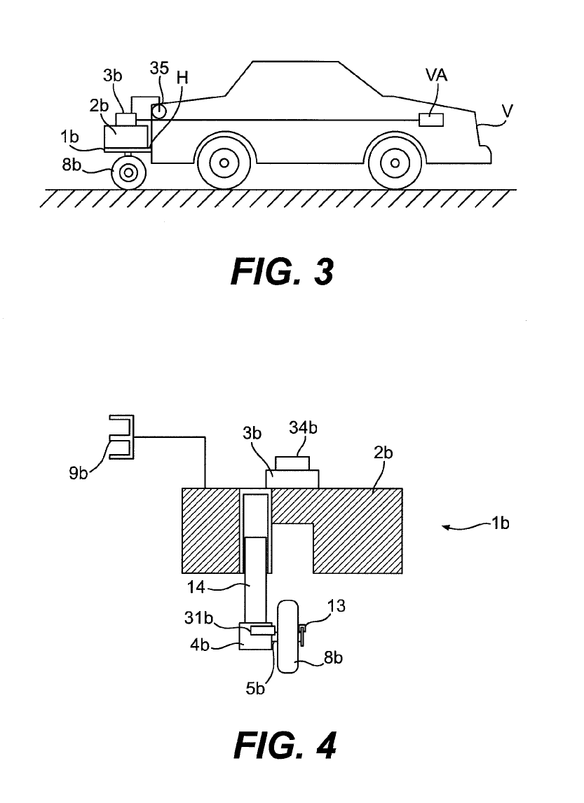

FIGS. 3 and 4 illustrate a power assist unit 1b. This power assist unit 1b incorporates many of the aspects of the systems for retrofitting a vehicle as described above with respect to FIGS. 1 and 2, but in this case is embodied in a towable arrangement that can be attached to an existing vehicle through a hitch arrangement such as a standard trailer hitch.

The power assist unit 1b includes a battery 2b, a control module 3b and a M/G 4b largely as described above with respect to FIGS. 1 and 2. Differences in the operation and arrangement of these components, however, will be described in detail below.

The M/G 4b has a drive shaft 5b that is connected to a drive wheel 8b. The drive wheel 8b may be connected directly to the shaft 5b or through a suitable transmission mechanism such as a gear arrangement or pulley arrangement.

As illustrated in FIG. 3, a vehicle V has a hitch H to which the power assist unit 1b is connected. The controller 3b, when the power assist unit 1b is hitched to the vehicle V, is interconnected with the brake lights or the brake light circuit 35.

In one preferred arrangement of the power assist unit 1b, the battery 2b has a plug 9b, and has the control module 3b mounted therewith. An inclinometer 34b is further provided to indicate the inclination of the vehicle, and is connected into the control module 3b. A fluid shock absorber 14 is connected between the M/G 4b and the battery 2b, for example, as separate components of the system. Thus, the M/G 4b is mounted with the drive wheel 8b and is allowed to move vertically in relation to the remaining components through the agency of the fluid shock absorber 14. A movement sensor 31b detects rotational movement of the drive wheel 8b. A safety brake 13 is also provided for the drive wheel 8b.

Accordingly, the hitch mechanism H provides an easy way to both attach and remove the power assist unit 1b to any vehicle that has a hitch mechanism that is capable of connecting to the unit and sufficiently strong to support the unit.

The control module 3b controls external charging of the battery 2b through the plug 9b and the recharging circuit. It also has a tie-in connection for the brake lights or brake light circuit 35, and can further provide tying connections to the vehicle charging system or any other electrical system which can be used for controlling the power assist unit 1b.

The electrical power from the battery provides an assist to the vehicle by operating the M/G 4b in the motor mode so as to reduce the amount of fuel that is used for distance travel. The electric power drive wheel 8b thus contacts the ground or pavement, and has sufficient traction to assist the movement of the vehicle.

The adjustable fluid shock system 14 is such as to be able to support the load of the power assist unit 1b. The full weight of the power assist unit 1b can be supported through the drive wheel mechanism, or part of the weight could be carried by the vehicle itself by transference to the vehicle through the hitch H.

The power assist unit 1b receives its electrical energy from the rechargeable battery. The battery can be part of the power assist unit, as illustrated, or it could be mounted and stored in or on the vehicle itself.

The control module is also preferably part of the power assist unit. However, the control module 3b can also be mounted separately from the power assist unit 1b. By mounting the control module 3b with the power assist unit as part of the same unit it can be moved to work with different vehicles without adding additional weight to the vehicle or difficulty in installation.

A plug-in receptacle can also be attached to the power assist unit 1b to provide further power, such as electrical power backup for any appliance that might need electrical energy. Thus the power assist unit 1b can also be used as an emergency backup system for a house, for example.

As with the above-described embodiments, the battery charging system turns off when the battery is fully charged.

### Sequence of Operation

The control module determines the mode of operation of the M/G 4b based upon the information received from the movement sensor 31b and the brake light circuit 35. The location of the movement sensor 31b, while illustrated as being adjacent to the drive wheel 8b, is not critical, and it can be attached to any part of the vehicle that will provide information of the distance traveled by the vehicle. The same information could alternatively be obtained from the vehicle electrical system, such as from the speed indicator.

The control module 3b accordingly detects vehicle acceleration through the input from the movement sensor 31b or other appropriate sensors. Preferably the control module 3b, as described with respect to the above embodiments, will not supply power to the M/G 4b unless the brake light is indicated as being off.

The control module 3b supplies power to the M/G 4b in the motor mode in an amount proportional to the amount of acceleration of the vehicle. This assists the engine in saving fuel.

When the control module 3b senses vehicle deceleration of a predetermined amount together with an on signal from the brake light circuit, the M/G 4b will be switched by the control module 3b to the generator mode to apply a load to the M/G 4b to charge the battery in an amount proportional to the amount of the vehicle's deceleration.

If the control module senses constant movement or steady speed within a predetermined tolerance, the control module 3b maintains the speed constant by applying an electric load to increase power to the M/G 4b in the motor mode, unless the control module 3b detects the brake circuit being on. If the brake circuit is detected as being on, a control module 3b will switch the M/G 4b to the generator mode to apply a charging load proportional the vehicle's deceleration.

The manual switch may also be provided so that the operator of the vehicle can switch the mode of the M/G 4b through activation of the switch.

The control module is programmed to optimize battery usage based upon information that is inputted manually into the control module 3. Information that should be entered into the control module includes, but is not limited to:
the weight of the vehicle
expected distance traveled
the type of route to be traveled, e.g. city traffic, freeway, etc.

Preferably a learn mode is activated and stored in the control module so that when the option of optimizing the battery energy is selected, the battery will be used to its maximum capacity for a frequently traveled route. Learned route information is thus stored by the control module and retrieved by the control module when such a frequently traveled route is input by the operator of the vehicle. Further, a number of frequently traveled routes can be stored and retrieved by the control module.

The inclinometer 34b may be included in the system of FIGS. 3 and 4 and operate in the same way, giving information to the control module, as with respect to the systems described in FIGS. 1 and 2 above. Thus, the microprocessor of the control module determines, from the information from the inclinometer, if the vehicle is on an incline, i.e. if the vehicle is going up or down a hill. The control module also uses the weight of the vehicle that is input during installation of the power assist unit 1b to adjust the load on the M/G 4b of the power assist unit in the motor mode or the generator mode to either assist the vehicle or recharge the battery. A variety of known inclinometers are available on the market that will work for this purpose.

### Battery Charging Operation

The battery may be charged in one of five different ways, or through a combination of these five different ways.

1. The M/G 4b is set in the generating mode either manually or under the control of the control module 4b, with the engine running, with a tie-in to the vehicle charging system, when the vehicle is stopped or when the battery reaches a low capacity condition; such a tie-in is illustrated schematically in FIG. 3 by connection of the control module 3b to the alternator VA.

2. The control module switches the M/G 4b to the generator mode when a deceleration of a predetermined amount is detected.

3. A control module 3b charges the battery 2b with the system as described with respect to FIG. 1 above.

4. The battery is charged by plugging the battery into an external power source such as the power grid, a remote generator, solar panels, etc.

5. The control module 3b detects that the vehicle is going down a hill and switches the M/G 4b to the generator mode.

It is an option to eliminate the generator mode from the unit. Thus a simple electric motor can be used in place of the M/G 4b. In this case the motor would only be used in assisting the movement of the vehicle, and not in regenerating the battery.

As illustrated by FIG. 3, the power assist unit 1b can be a separate unit attached to the vehicle by a hitch mechanism. It can be designed to be an attractive trailer unit that includes brake, turn and running lights tied into the vehicle electrical system. The size of the power assist unit does not need to add more than about an additional foot to the length of the vehicle.

In addition, similar to known trailers, a brake can be added to the power assist unit 1b to help stop the additional weight of the power assist unit. The brake may be optionally tied into the control module so as to be activated when the deceleration reaches a predetermined amount. A suitable safety brake 13 is illustrated in FIG. 4. It can be operated by an electromagnetic arrangement, or it can be a mechanical brake having an inertia sensor. The brake could also be formed by having the electric motor reverse direction, thus using the electric motor to stop the power assist unit 1b if regeneration brake feathering is not sufficient stopping force when the M/G 4b of the power assist unit 1b switches to the generator mode.

The power assist unit 1b can be designed to work in combination with the system described in FIG. 1, or with both the systems of FIGS. 1 and 2. The preferred combination for the power of assist unit 1b is together with the system described in FIG. 1, however.

Sequence of Operation of the Combination of the System of FIG. 1 with the System of FIGS. 3 and 4

The control module, which could be either the control module 3 or the control module 3b, or which could be combined into a single control module, determines the sequence of operation of the M/G 4 and the power assist unit 1b and the mode in which they will operate. This can also be determined by a manual switch.

If the vehicle is not moving relative to the ground as detected by the movement sensor 31, 31b and as computed by the control module 3, 3b, the combustible fuel engine will be turned off after a predetermined amount of time; the engine may also be turned off by a switch activated by the operator of the vehicle. At the same time that the engine is turned off the clutch 8 is disengaged from the M/G 4. The M/G 4 continues to power the A/C through the first pulley system, being switched to the motor mode either manually or by the control module 3, 3b, receiving electrical energy from the battery 2. Other accessories can be powered by the battery as well. If the A/C or any other accessories that are powered by the M/G 4 are not needed but are left on, the M/G 4 will be shut off in order to conserve the battery life. The internal combustion engine will not be consuming fuel at this point as it will have been turned off. Accessories that can be powered by the battery but not by the M/G 4 are connected by wire. The power assist unit 1b will be powered off.

When the vehicle accelerator paddle is depressed, or when a switch is activated manually, or when a combination of both occurs, with the intent to move the vehicle forward, the control module 3, 3b will cause the clutch to engage the second pulley system so as to start the combustible fuel engine. A preferred option is that the A/C and other accessories that are powered through the first pulley system be placed in the off position by the control module 3, 3b for a predetermined period of time so that the M/G 4 can be allowed to stop before the clutch 8 is engaged; this prevents the clutch from wearing excessively, and it also increases the amount of power that is available to start the engine and assist the engine during initial acceleration. The M/G 4 continues to stay in the motor mode to assist the engine to save fuel until it is either shutoff manually or it is shut off or has its mode changed by the control module 3, 3b. The power assist unit 1b will also be powered on at the same time, receiving a control signal from the control module 3, 3b. As noted, a separate control module for the power assist unit 1b may not be needed, but separate control modules can be used.

The control module 3, 3b is preferably programmed so that vehicle acceleration is detected and power is increased to the M/G 4 and the power assist unit 1b in the motor mode in order to assist the engine to save fuel. The control module 3, 3b is further preferably programmed so as to increase the amount of power that is input to the M/G 4 and the power assist unit 1b in the motor mode in an amount that is proportional to the amount of acceleration of the vehicle.

If the control module 3, 3b senses vehicle deceleration of a predetermined amount, the M/G 4 will be switched by the control module 3, 3b to the generator mode so as to apply a load on the M/G 4; the power assist unit 1b will similarly have the M/G 4b switched to the generator mode, and both will have a load applied thereto that is proportional to the amount of deceleration so as to produce electrical energy to recharge the battery. The control module 3, 3b will monitor the revolutions of the combustible fuel engine in the generator mode through the RPM sensor 32 and will adjust the load of the M/G 4 in the generator mode to ensure that the engine RPM of the combustible fuel engine does not drop below a predetermined amount.

### Fourth Embodiment

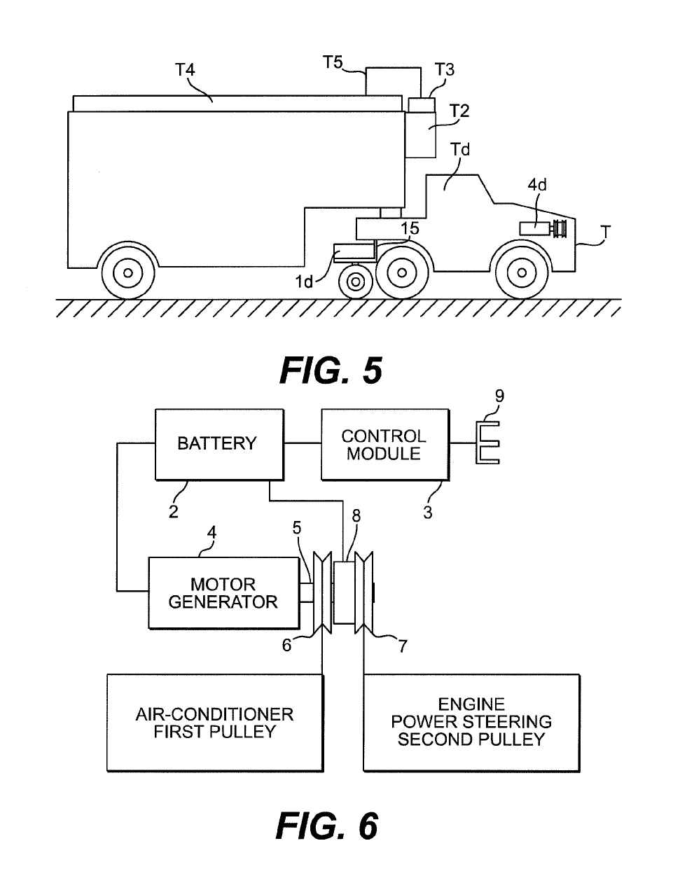

FIG. 5 illustrates a variation of the embodiment of FIGS. 3 and 4. The comments above regarding the embodiments of FIGS. 3 and 4 fully apply to this embodiment except for differences in construction and operation as noted below.

Here the power assist unit 1d is attached to a standard tractor/trailer truck T. Thus the unit 1d can be attached by connection to the tractor Td of the tractor trailer truck T. This can be via a standard hitch mechanism or could be another suitable mechanism that might more permanently connect the power assist unit to the tractor. The power assist unit 1d can also be attached to the tractor without a trailer in place. Thus the unit can be attached to the frame of the tractor, or directly to the axle so as to move with the rear axel of the tractor. The power assist unit 1d is thus structured so as to support the weight of the power assist unit 1d along with the battery or batteries thereof and also part of the weight of the truck.

With this arrangement, the rechargeable battery can be included as part of the power assist unit 1d and/or be connected to other batteries on the tractor and/or the trailer such as the illustrated battery T2. Either the trailer or the tractor Td of the truck T can have solar panels T4 mounted thereto for the purpose of recharging the batteries.

A motor/generator M/G 4d as described with respect to the embodiment of FIG. 1 can also be used with the combustible fuel engine of the tractor Td in place of the standard alternator or generator to assist in the reduction of fuel use; alternatively the M/G 4d can be added to the engine at a separate location leaving the standard alternator in place. The operation of such an M/G 4d would be the same as described with respect to FIG. 1 above.

Thus, a power assist unit 1d can be added to a truck T in combination with the embodiment of FIG. 1 above and work in the manner as described above.

Noting FIG. 5, solar panels T4 have a connection T5 connecting them to a trailer battery charger T3 for charging trailer battery T2. Such a trailer battery T2 can be used to drive the M/G of the power assist unit 1d.

### Variation of First Embodiment

FIG. 6 illustrates an arrangement similar to that of FIG. 1, in which a motor generator 4 replaces the standard alternator or generator of a vehicle. The air conditioner of the vehicle can be powered by the combustible fuel engine when the clutch 8 is engaged, being driven through the second pulley system. The air conditioner of the vehicle can also be driven by the M/G 4 with the M/G 4 in the motor mode with the clutch 8 disengaged. This allows the air conditioner and other appliances to be used without the combustible fuel engine actually running. Such an arrangement allows the saving of fuel by eliminating the need to run the engine while the vehicle is parked. The M/G 4 can be controlled by a simple tie-in to existing controls that are used by a vehicle.

Thus, what is different from the embodiment of FIG. 1 is that there is no tie-in to a movement sensor, an rpm sensor and an engine idle switch as part of the input to the control module 3. In operation, the control module 3 controls the M/G 4 to apply a constant load in the motor mode to assist the engine. The control input will, however, be tied into existing controls (not shown) of the vehicle to determined if the engine is running.

In this embodiment, the air conditioner of the vehicle is similarly operated by the M/G 4 in the motor mode without the need for running the engine, allowing the air conditioner to be run while the vehicle is parked. The battery is then the source of power for running the air conditioner for extended periods of time, thus saving fuel. This may be especially useful for trucks where the air conditioner either is left running for extended periods of time without the vehicle moving.

### Information Flow

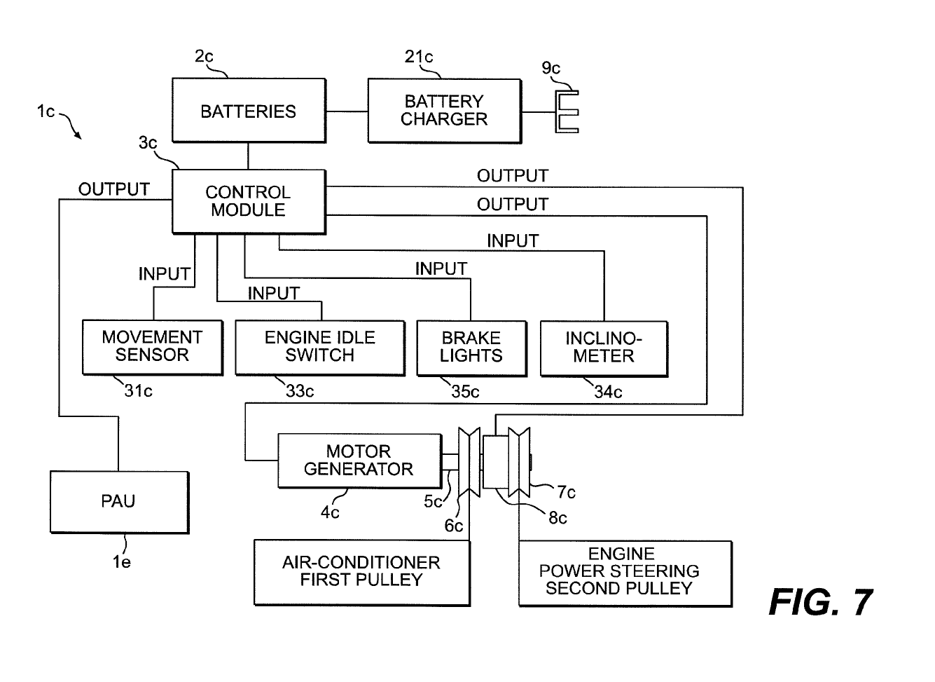

FIG. 7 is a flow diagram that shows the flow of information to a control module which can be used to control the power assist unit or the motor generator of the embodiments described above. Thus, control module 3c is connected to motor generator 4c, outputting a control signal to control the motor generator 4c. A control module 3c further provides an output signal to the clutch 8c that is interconnected with the drive shaft 5c of the motor generator 4c and the air conditioner first pulley system of 6c and the engine power steering second pulley system 7c.

Plug 9c, battery charger 21c and batteries 2c are interconnected with the control module 3c so that the control module 3c can control the recharging of the batteries and can provide power to the motor generator 4c and receive power from the motor generator 4c.

As described above in the respective embodiments, the control module 3c can receive inputs from a movement sensor 31c, engine idle switch 33c, brake lights or brake light circuit 35c and an inclinometer 34c. As also schematically illustrated by FIG. 7, a power assist unit as described with respect to FIGS. 3-5 can be combined with the system of FIG. 1 or FIG. 2, for example, and run by a single control module 3c.

### Fifth Embodiment

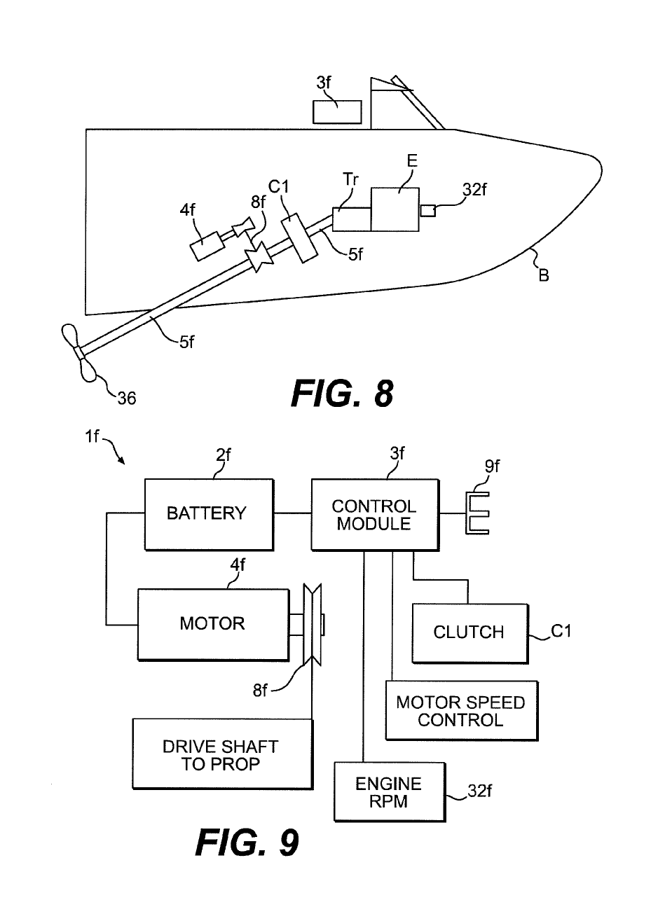

FIGS. 8 and 9 illustrate an arrangement of the adaptation of the present invention to a typical boat drive system. Accordingly, a battery powered electric motor 4f is provided so as to assist the powering of a boat in a manner that is independent of the engine E or that may assist the combustible fuel engine E so as to reduce fuel usage.

The system for retrofitting a boat is designated by reference number 1f. The system includes a control module 3f interconnected with a rechargeable battery 2f, a plug for recharging the battery 9f and an electric motor 4f. The components and operation of this system is similar to the embodiments described above, except that the motor 4f is simply a motor, and is not a motor/generator. The drive shaft of the motor 4f is connected to a transmission for a propeller shaft or drive shaft 5f for driving a propeller 36. The transmission 8f may constitute a pulley system or a gear system, for example.

A boat B includes a main boat motor speed control. The control module 3f may be incorporated as part of the motor speed control connected thereto as shown in FIG. 9. The combustible fuel engine E of the boat B has an RPM sensor 32f that is interconnected with the control module 3f. A transmission TR connects the engine with the drive shaft 5f. A clutch CL is under the control of the control module 3f. The clutch CL may also be installed between the engine and the transmission, but the point is to allow the drive shaft to be engaged or disengaged from the engine. When the clutch CL is engaged with the engine, the battery powered electric motor 4f can be used to assist the engine E in order to reduce fuel usage. The amount of electric power that is used to assist the engine is under the control of the control module 3f, being tied into the RPM sensor 32f of the engine E, and is controlled so as to optimize the amount of assist while preventing overpowering the engine.

The control module 3f is programmed to apply a load to the electric motor that is proportional to the RPM of the engine. When the clutch CL is disengaged from the engine, the electric motor 4f can be used to power the drive shaft independently of the engine E.

The motor speed control as illustrated in FIG. 9 is what the operator uses to control the speed of the boat. The electric motor 4f is preferably a reversible electric motor so that when the operator chooses to run the drive shaft in a reverse direction so as to for example reverse the direction of the boat B, the motor 4f can also assist in this movement.

The electric motor 4f, as noted, can be attached to the drive shaft 5f by a pulley or gear arrangement. The electric motor could also be attached to the clutch assembly through a pulley or gear instead of direct attachment to the drive shaft 5f. Alternatively, it is possible to eliminate the drive clutch CL and to attach the electric motor to the drive shaft. To disengage the engine, the transmission could be placed neutral with the engine off, however, this would add additional friction.

FIG. 9 illustrates the basic schematic arrangement and information flow of the system. A microprocessor of the control module provides outputs and necessary signals in order to control the electric motor 4f, the clutch CL, etc. The microprocessor also receives input from the engine RPM sensor 32f and the motor speed control under the control of the operator. The battery 2f can be recharged by plugging it into an external power source as described previously, or by using an on board fuel powered generator, or the engine itself.

### Sixth Embodiment

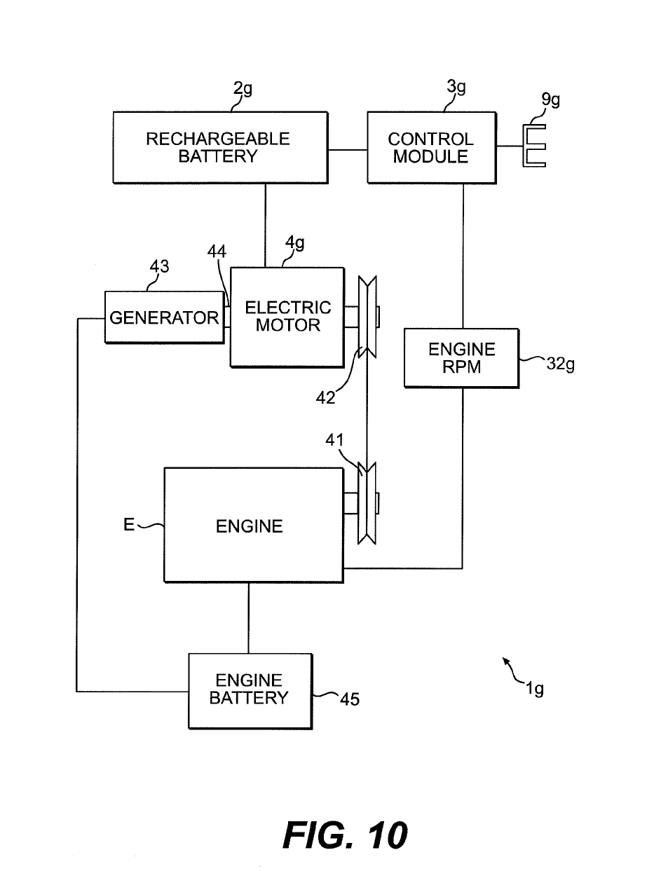

FIG. 10 illustrates an arrangement that uses an electric motor 4g having an electric motor pulley 42 that is connected with an engine pulley 41 connected with a combustible fuel engine E of the vehicle. The engine pulley 41 is connected with the crank shaft. While a pulley system is illustrated, this could also be a gear system. The electric motor 4g is provided to assist the engine E in reducing its fuel usage.

The electric motor 4g is provided in place of the standard alternator as shown in FIG. 1. A control module 3g controls the electric motor 4g so that electric motor 4g increases its power to the motor proportional to the RPM of the engine. For this purpose, the engine RPM sensor 32g is connected with the control module 3g.

The illustrated arrangement of FIG. 10 shows a built in or attached generator or alternator 43 that is attached to the electric motor 4g through an attachment 44, which generator or alternator 43 is used to charge the battery that is used as part of running the combustible fuel engine E. The engine battery is illustrated by reference number 45 in the drawing figure. With this arrangement, the electric motor receives its power from the rechargeable battery 2g under the control of the control module 3g.

An alternative arrangement is to separate the generator or alternator from the electric motor 4g that is used to assist the engine by installing the electric motor at a separate location, allowing the standard alternator to remain in place. Both arrangements can work as a combination of FIGS. 8 and 9 as discussed above, as well as the prior discussed arrangements which show the motor generator attached to the engine. In this case the standard alternator will remain in place and the motor/generator M/G as described above will be installed at a separate location. If the standard alternator remains in place, however, it may not be necessary to run the M/G in the generator mode, as the standard alternator would charge the engine battery.

### Seventh Embodiment

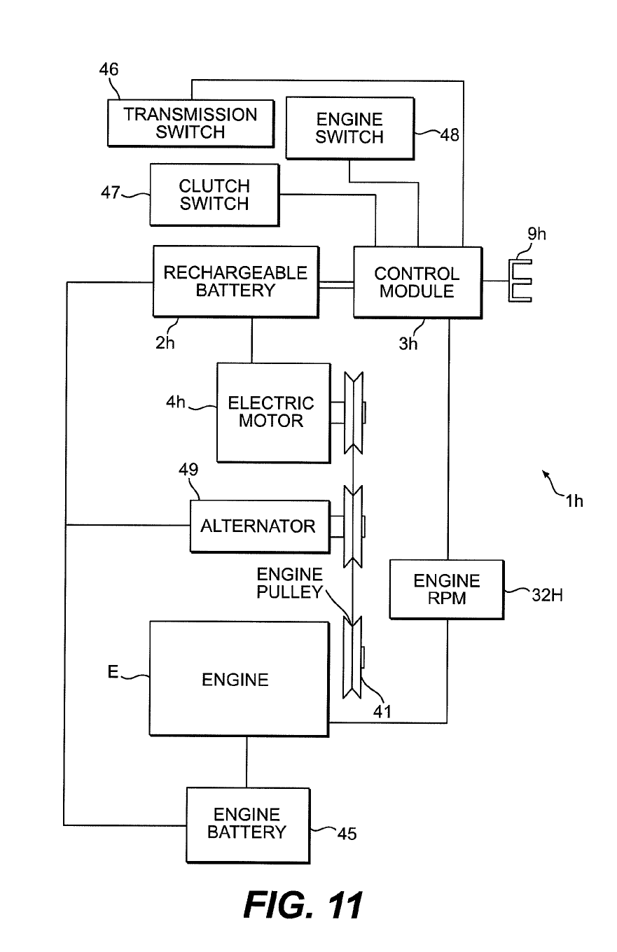

FIG. 11 illustrates an alternative arrangement of an electric motor. In this arrangement an electric motor 4h is interconnected with an alternator 49 and the combustible fuel engine E through the agency of the engine pulley 41. The electric motor 4h is interconnected with the rechargeable battery 2h and the control module 3h, also having the plug connection 9h. A clutch switch 47, a transmission switch 46 and an engine switch 48 are connected with the control module 3h. The system overall is designated by reference number 1h.

The electric motor 4h assists the engine E in reducing fuel usage. The standard alternator 49 remains in the system to charge the engine battery 45 as well as the extra rechargeable battery 2h when the engine is running. With this arrangement, the electric 4h receives its power from the rechargeable battery 2h and/or the engine battery 45, and is controlled by the control module 3h.

When the control module receives a signal from the clutch switch 47 that the clutch has been depressed for a predetermined period of time, then the clutch will disengage the transmission and at the same time the engine will be shut off in order to save fuel.

When the clutch is released, the electric motor will start the engine just before the transmission is engaged. The electric motor 4h will continue to assist the engine by increasing the electric load that is provided to the electric motor 4h in an amount proportionate to the RPM of the engine under the control of the control module 3h.

The transmission switch 46 also provides information to the control module 3h so that the control module 3h detects when the transmission is placed in neutral in order to allow the clutch to be released with starting of the engine.

The rechargeable battery 2h can be recharged by plugging the plug 9h into an external power source, or by an on board fuel powered generator, or the engine E.

1. A system for retro-fitting a combustible fuel vehicle to form a plug-in electric hybrid vehicle, comprising:
an electric motor/generator unit that has an electric motor mode and an electric generator mode and that can be switched between said motor mode and said generator mode in response to a switching signal, said motor/generator having an output/input drive shaft;
a vehicle drive train interconnection that is connected with said drive shaft of said motor generator and that connects said motor generator to the vehicle drive train so that said motor/generator unit can provide power into the vehicle drive train and receive power from the vehicle drive train;
a sensor that determines an operating condition of the vehicle that corresponds to movement of the vehicle;
a rechargeable battery that is connected to said motor/generator so as to provide electrical power to said motor generator in said motor mode and so as to receive electrical power from said motor generator in said generator mode, said rechargeable battery having a recharge plug and a recharging circuit so that said battery can be recharged by plugging said recharge plug into a source of electrical power; and
a controller that is connected with said motor/generator unit, said rechargeable battery and said sensor, that determines, in response to a signal from said sensor, if the vehicle is moving and if the vehicle is accelerating, decelerating, or moving at a constant speed, that controls said motor/generator unit and said rechargeable battery to provide power to said motor/generator in said motor mode and to receive power from said motor/generator in said generator mode to recharge said rechargeable battery, and that switches said motor/generator unit between said motor mode and said generator mode based on determining whether the vehicle is accelerating, decelerating or moving at a constant speed.

2. The system of claim 1, wherein said sensor is a vehicle movement sensor that measures movement of the vehicle relative to the ground.

3. The system of claim 1, wherein said controller controls the rechargeable battery and said motor/generator unit to provide electrical power to said motor/generator unit in said motor mode proportionate to an amount of acceleration determined by said controller and to place a load proportionate to an amount of deceleration determined by said controller in said generator mode.

4. The system of claim 1, wherein said vehicle drive train interconnection comprises a clutch mechanism that is connected to and operable by said controller.

5. The system of claim 4, wherein said output/input drive shaft has an air-conditioner pulley attached thereto and said controller controls said clutch mechanism to disconnect said motor/generator unit from the vehicle drive train so that, when the combustible fuel engine of the vehicle has been turned off, said motor/generator unit can continue to rotate said air-conditioner pulley.

6. The system of claim 5, and further comprising a power steering pulley connected to said output/input drive shaft.

7. The system of claim 5, and further comprising an engine idle switch connected with said controller, said engine idle switch being operable to turn off the combustible fuel engine after a predetermined period of time in which no pressure has been detected on an accelerator pedal of the vehicle.

8. The system of claim 1, wherein said motor/generator unit comprises a differential mounting bracket that mounts said motor/generator unit to a differential of the vehicle, and said vehicle drive train interconnection connects to the drive train of the vehicle adjacent to the differential.

9. The system of claim 8, wherein said vehicle drive train interconnection comprises a pulley or gear system connecting said output/input drive shaft to a flange of the differential.

10. The system of claim 1, and further comprising an inclinometer that detects an inclination of the vehicle to determine whether the vehicle is traveling uphill, downhill or horizontally, said inclinometer being connected to said controller, wherein said controller controls said motor/generator unit and said rechargeable battery to provide power to said motor/generator in said motor mode and to receive power from said motor/generator in said generator mode to recharge said rechargeable battery based at least in part on whether the vehicle is traveling uphill, downhill or horizontally.

11-19. (canceled)
